(19) United States
(12) Patent Application Publication
(10) Pub. No.: US 2002/0087353 A1
(43) Pub. Date: Jul. 4, 2002

(54) Method of connecting calls between a business card transmitter and a business card receiver through the medium of a web business card sent by the business card transmitter and system for the same

(75) Inventor: Hyung Nam Han, Seoul (KR)

Correspondence Address: OSTROLENK FABER GERB & SOFFEN, 1180 AVENUE OF THE AMERICAS, NEW YORK, NY, 100368403

(73) Assignee: Telefree Inc.

(21) Appl. No.: 10/040,399

(22) Filed: Nov. 9, 2001

(30) Foreign Application Priority Data
Sep. 25, 2001 (KR) P. 2001-59437
Jan. 4, 2001 (KR) P. 2001-428

(51) Int. Cl. G06F 17/60

(52) U.S. Cl. 705/1

(57) ABSTRACT

Disclosed are a method of providing a call connecting service between a business card transmitter and a business card receiver through the medium of a web business card which is so made on a web as to have a call connecting function inside and is transmitted to a desired receiver via e-mail and a system for the same. The system issues, based on web business card information inputted by the business card transmitter, a web business card in which a call button having a call connection requesting function is included and transmits the web business card to at least a designated e-mail address. When the business card receiver who received the web business card activates the call connection requesting function by clicking the call button with the computer, the system, in response thereto, receives call connecting information of a communication tool to be used by the business card receiver from the business card receiver's computer and respectively dials the business card transmitter's telephone number which corresponds to the clicked call button and the business card receiver's communication tool. When the business card transmitter and the business card receiver respond to a call connection with respect to such dialing, a call is connected between them. Post-processes such as calculation of a calling fee based on calls are made. The web business card that the business card receiver sees through his or her own computer is the latest web business card which is stored in the above system.

### BACKGROUND OF THE INVENTION

1. Field of the Invention

The present invention relates to a technology of, in a web site, making a web business card in which a call connecting function is embedded, transmitting the web business card to desired persons via e-mail, and providing call connecting service between a business card transmitter and a business card receiver through the medium of the web business card.

2. Description of the Related Art

In the course of business or a social life, business cards or name cards are used as a means of introduction or publicity. Conventionally, such paper cards on which personal information is printed have been widely used. Recently, several kinds of business cards which are exchangeable through a web or mobile telecommunication networks have been introduced and they are called a web business card or an electronic business card.

Practical usefulness of such prior web business cards is limited. Like a general paper business card, they are made without any particular functions for the call connection in a web site and are transmitted to desired persons via email. That is, the typical prior web business cards are made in such a way that letters related to personal information on the transmitter's name, position within his or her company, telephone or facsimile number, and e-mail or home page address are properly arranged together with pictures or characters, and are transmitted to a third party via e-mail. If the e-mail or home page address included in the web business card is made in the hyper text mark-up language (HTML), the web business card can provide a function at the most that a business card receiver can conveniently send an e-mail message to a business card transmitter or that the business card receiver can access to the home page.

The main purpose of such web business cards is to advertise certain goods or services. Taking account of this purpose, it is necessary to invite more business card receivers to call the business card transmitter. The more powerful incentive to the call by the business card receivers may be such a thing that the business card receiver can conveniently call the business card transmitter or that a calling fee is charged only on the business card transmitter, accordingly the business card receiver does not feel that he or she is burdened with the calling fee.

Further, the prior web business card cannot provide a call connecting function between the business card receiver and the business card transmitter. When the business card receiver wants to have a call with the business card transmitter, the business card receiver should directly contact, by calling with his or her own telephone in person, the business card transmitter on the telephone number known from the received web business card. In this case, the calling fee is charged on the business card receiver and therefore an attraction that makes the business card receiver to call the business card transmitter is not great.

And also, in the prior web business cards, the business card receiver is restricted in terms of a communication means by which the business card transmitter is connected. According to circumstances, the business card receiver may want a call connection with the business card transmitter via a personal computer (PC) other than a telephone. That means that more comprehensive approaches are required to allow the business card transmitter and the business card receiver to be connected via various communication vehicles.

Meanwhile, it is necessary to update all the time the business card transmitter's information to which the business card receiver accesses. It will be troublesome for the business card transmitter to re-transmit the web business card with updated information such as a new telephone number whenever the business card transmitter's information is changed. Moreover, if a renewal of information is not made in a timely fashion due to such a hassle, this will cause inconvenience to the business card receiver.

Taking account of the above factors, it is worth paying attention to the fact that various convenience and advantages in respect to the call connection can be obtained from a service that the web business card is used as a medium of the call connection between the business card transmitter and the business card receiver based on the Internet and telecommunication networks.

### SUMMARY OF THE INVENTION

Accordingly, it is a first object of the present invention to provide a method of call connecting service, through the medium of a web business card, that a business card transmitter makes the web business card in a desired form and transmits the desired web business card to desired business card receivers via e-mail, that the business card receivers conveniently have a call connection with the business card transmitter at a low price by using a call connecting function embedded in the received web business card, and that a method of charging a calling fee can be variously selected.

A second object of the present invention is to provide a service system for carrying out the call connecting service method as above.

In order to accomplish the first object of the present invention, there is provided a method of providing a call connection service between a first party and a second party by using a system connected to a PSTN and/or a mobile telecommunication network and the Internet, comprising the steps of: issuing a web business card, in response to a request of the first party by a first client computer via the Internet, including at least one or more call buttons having a call connection requesting function based on web business card information provided by the first party via the first client computer, and transmitting the web business card to one or more e-mail addresses designated by the first party; in response to a call connection request, activated by clicking the call button of the web business card in a second client computer, via the Internet by the second party received the web business card of the first party via e-mail, receiving from the second client computer call connection information of a communication means to be used by the second party, and respectively dialing a telephone number corresponding to the clicked call button of the first party and the call connection information of the communication means of the second party; and connecting a call between a telephone of the first party and the communication means of the second party when the first party and the second party respond to a call connection attempted by the dialing, and thereby the call connection service between the first party and the second party being provided by the system through the medium of the web business card.

In the method, the call connection information of the communication means of the second party can be either an Internet protocol address of the second client computer or a telephone number of a telephone to be used by the second party for the call.

The method further comprises the steps of providing the first client computer with a web business card list of the first party stored in the system in response to the first party's request, receiving at least one or more e-mail addresses from the first party via the first client computer, and transmitting a certain web business card selected by the first party from the web business card list to the received e-mail addresses.

The method further comprises the steps of calculating a calling fee by counting a calling period of time between the first and second parties, storing data of an advance payment paid by the first party in a database, and deducting the advance payment from the calculated calling fee.

The method provides, for issuing the web business card, the first client computer with a web page in which a web business card making means is included in response to the first party's request. As an example of the web business card making means, there is provided the web business card making means which has the function that the first party can design a web business card in a way that he or she wants. It is preferable to provide the web business card making means which has the functions of providing the first party with at least one or more prepared web business card samples for selecting a desired web business card sample and producing a web business card by arranging the first party's personal information in the selected web business card sample.

Issuing and transmitting of the web business card comprises the steps of: providing the first client computer with a web page including a web business card making means in response to the request of the first party; receiving, by the system, the web business card made by the first party with the web business card making means from the first client computer, the received web business card including at least one or more call buttons and the first party's telephone number which corresponds to each call button; storing the received web business card, together with an ID number which is given by the system with respect to each call button which is included in the received web business card, in a database of the system; and transmitting the web business card for the issuing to an e-mail address of the first party.

The method further comprises the steps of, in response to a request of the first party, providing the first client computer with a web page including information related to the web business card of the first party after extracting the web business card from the database and, when the first party requests a renewal by correcting the information, updating the database with the corrected information. The web business card is stored in a database managed by the system. The web business card transmitted to the second party includes link information which can specify a corresponding web business card among stored web business cards in the database. When the second client computer accesses to the system, the system receives the link information from the second client computer, extracting from the database a web business card which corresponds to the link information and providing the second client computer with the extracted web business card. Accordingly, the web business card which is displayed on the second client computer is the web business card currently stored in the database.

In order to accomplish the second object of the present invention, a system providing a call connection service between a first party and a second party through the medium of a web business card by comprising: a web server connected to the Internet; a call server which is connected internally to the web server and externally to the Internet, a PSTN and/or a mobile telecommunication network; and a database server connected to the web server and the call server. The web server comprises the functions of issuing the web business card including at least one or more call buttons, which have a call connection requesting function, made based on web business card information which is provided by the first party via a first client computer, transmitting the web business card designated by the first party via the first client computer to at least one or more e-mail addresses designated by the first party, and when the second party received the web business card via e-mail executes a call connection requesting function of a specific call button included in the web business card by using a second client computer, in response to the execution, inquiring into the first party's telephone number corresponding to the specific call button in the database server, and transmitting call connection information of a communicating means of the second party, together with the telephone number of the first party to the call server. The call server comprises the functions of respectively dialing the telephone number of the first party and the call connection information of the second party which are transmitted from the web server and, when the first party and the second party respond to a call connection, connecting a call between a telephone of the first party and the communication means of the second party. The database server comprises the functions of storing member information provided via the web server and/or the call server, information related to the web business card, information related to the call between the first party and the second party, etc. in a database, and providing a database-related service such as a renewal of stored data and a response to requested data.

The call connection information of the communication means of the second party can be either an Internet protocol address of the second client computer to be used by the second party for a call or a telephone number of a telephone to be used by the second party for a call.

The call server includes a gate keeping means and one or more trunk gateway means. The gate keeping means selects at least one or more trunk gateway means which are capable of performing a call connection at the least cost among available trunk gateway means based on the first party's telephone number and the second party's telephone number which are transmitted from the web server and which instruct the call connection by transmitting the first party's telephone number and the second party's telephone number (in the case of a phone-to-phone communication) or the second client computer's Internet protocol address (in the case of a PC-to-phone communication) to the selected trunk gateway means. The selected trunk gateway means dial the first party's telephone number and the second party's telephone number to open communication channels, respectively, and perform controls for establishing the call connection between the first party's telephone number and the second party's telephone number, so that both parties can have a telephone conversation.

### BRIEF DESCRIPTION OF THE DRAWINGS

The above objects and advantages of the present invention will become more apparent by describing in detail preferred embodiments thereof with reference to the attached drawings, in which:

FIG. 1 is a conceptual configuration of a system for providing a call connecting service between a business card transmitter and a business card receiver through the medium of a web business card according to the present invention;

FIG. 2 illustrates an example of the web business card issued according to the present invention;

FIG. 3 illustrates another example of the web business card issued according to the present invention;

FIG. 4 illustrates web business card samples from which the business card transmitter can select at the time of making the web business card;

FIG. 5 illustrates a window into which the business card transmitter enters information to be included therein at the time of making the web business card;

FIG. 6 illustrates a window in which the business card transmitter can edit a draft of the web business card with editing tools in such a fashion that he or she likes;

FIG. 7 illustrates an input window for transmitting the issued web business card to the business card receiver;

FIG. 8 illustrates a window that, in the case of a phone-to-phone communication, the business card receiver makes a call connection request through the medium of the web business card received from the business card transmitter;

FIG. 9 is a block diagram illustrating in more detail the configuration of a call connecting service system according to the present invention;

FIG. 10 is a flow chart representing a process that the business card transmitter issues a desired web business card by accessing to the call connecting service system according to the present invention;

FIG. 11 is a flow chart representing a process for providing call connecting service in the phone-to-phone communication between the business card receiver and the business card transmitter through the medium of the web business card in response to the business card receiver's request; and

FIG. 12 is a flow chart showing a process for providing call connecting service in a PC-to-phone communication between the business card receiver and the business card transmitter through the medium of the web business card in response to the business card receiver's request.

### DETAILED DESCRIPTION OF THE PREFERRED EMBODIMENT

Hereinafter, the preferred embodiment of the present invention is explained in detail with reference to the attached drawings.

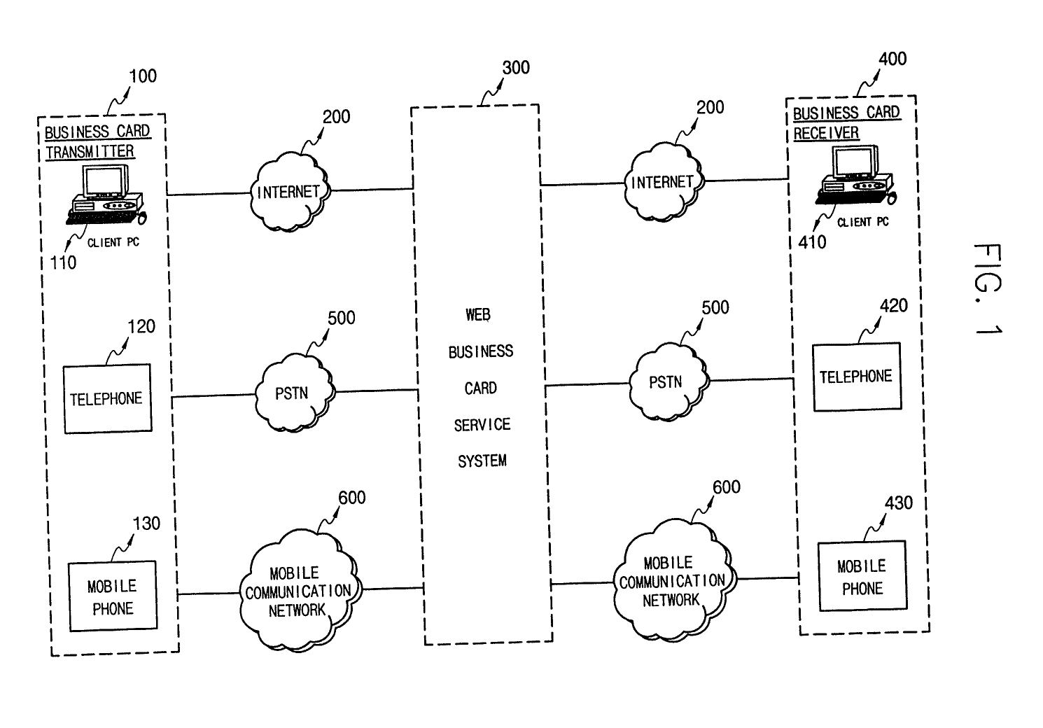

FIG. 1 shows an overall conceptual configuration of a system for providing a call connecting service between a business card transmitter and a business card receiver through the medium of a web business card according to the present invention.

In FIG. 1, with being connected to the Internet 200, a web business card service system 300 provides various services in response to clients' requests such as an issue of the web business card at the request of the business card transmitter, transmission of the issued web business card to designated receivers via e-mail, and revision and renewal of the issued web business card and information included in the issued web business card. And also, with being further connected to a public switched telephone network (PSTN) 500 and/or a mobile telecommunication network 600, the service system 300 provides various services related to a call connection between a business card transmitter 100 and a business card receiver 400 in response to the call connection request of the business card receiver 400.

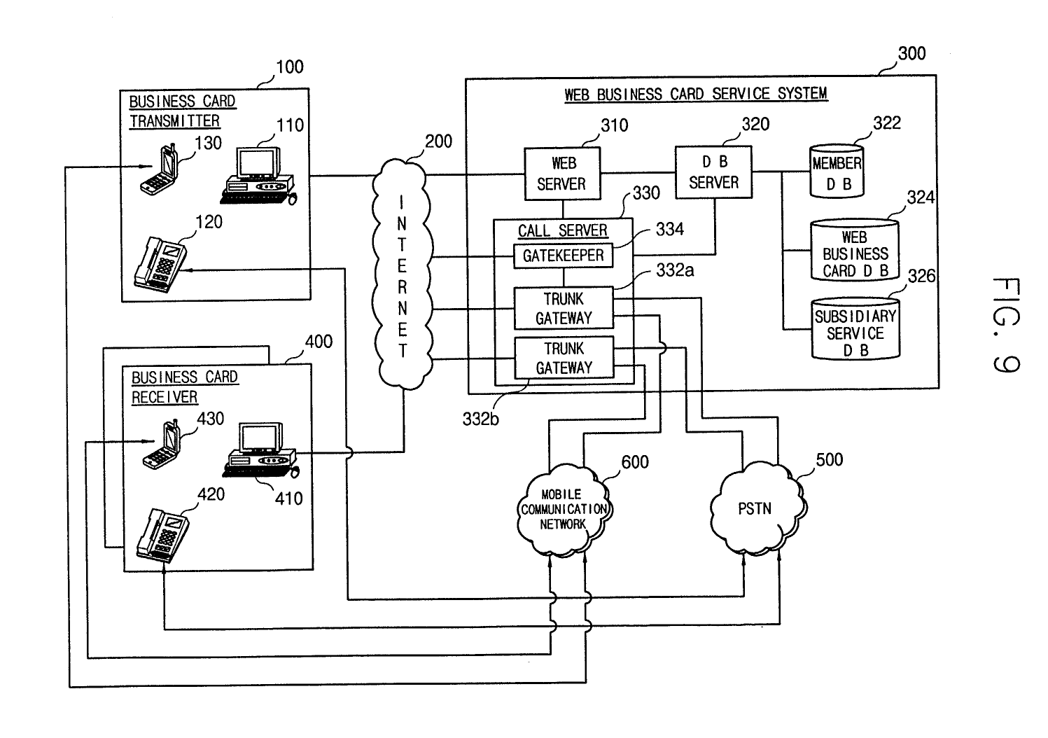

FIG. 9 illustrates the configuration of the web business card service system 300. The service system 300 has a web server 310, a call server 330, a database server 320 and some conventional communication support devices such as a router (not shown). These resources are integrated on the Intranet and/or the Internet.

The web server 310, in response to requests of computers 110, 410 accessed via the Internet 200, serves the computers 110, 410 with web pages in the form of a formatted document. More concretely, in cooperation with the database server 320 and the call server 330, the web server 310 provides services of issuing a desired web business card at the request of the computer 110 of the business card transmitter, transmitting the issued web business card to the computer 410 of the designated business card receiver via e-mail, and inquiring into and providing various information requested by the clients, and services related to a call connection request of the business card receiver 400, controls of the call connection between the business card receiver 400 and the business card transmitter 100 and a furnishing of information on how the call connection, etc. proceeds.

The database server 320 stores information of members provided via the web server 310 or the call server 330, information related to the web business card, information related to calls between the business card transmitter 100 and the business card receiver 400, and other necessary data in a member database 322, a web business card database 324 and an extra service database 326. The database server 320 provides database-related service such as database management for renewal of stored data and querying the database concerned about requested data.

A communication between the business card transmitter 100 and the business card receiver 400 that the service system 300 supports can be performed by one of the following communication methods, a phone-to-phone communication, a PC-to-phone communication, a phone-to-PC communication and a PC-to-PC communication. The phone-to-phone communication means a call between one phone 120 or 130 of the business card transmitter 100 and one phone 420 or 430 of the business card receiver 400. The PC-to-phone communication means a communication that the business card receiver 400 uses an Internet phone function of the PC 410 and the business card transmitter 100 uses the telephone 120 or 130, and the phone-to-PC communication vice versa. The PC-to-PC communication means a communication that both the business card transmitter 100 and the business card receiver 400 use the Internet phone function of the PCs 110, 410.

The business card transmitter 100 needs the computer 110 for receiving various services, for example, a request for issuing the web business card to the service system 300 via the Internet 200. Likewise, the business card receiver 400 also needs the computer 410 for receiving various services, for example, a request of a call connection with the business card transmitter 100, through the medium of the received web business card, to the service system 300 via the Internet 200. And also, in order to make a call between the business card transmitter 100 and the business card receiver 400 via the phone-to-phone communication, each party needs to have the telephone 120 or 420 and/or the mobile phone 130 or 430, and a web browser should be installed in the computers 110, 410. This web browser enables the parties to input call connection request information, to request a call control and a call status browsing by a computer communication with the web server 310 and to check the results received from the web server 310.

Further, for calls, the computers 110, 410 need to have Internet phone devices such as a duplex sound card, a speaker and a microphone, to be accessible to the Internet, and to be installed with a sound signal processing program having a function of controlling the sound card to compress and record a sound signal in the sound card or to decompress the sound signal recorded in the sound card to the original sound signal, and with an Internet phone program for controlling an Internet call and the communication of the sound signal between the computers 110, 410 and the service system 300 through the Internet 200. Such voice compression is preferably carried out according to an international standard specification, for instance, G723.1.

Having connections for communication with the PSTN 500, the mobile telecommunication network 600 and the Internet 200 which are external to the system 300 and at the same time to the web server 310 and the database server 320 which are internal to the system 300, the call server 330 controls a call connection in accordance with a designated communication method in response to a call connection request of the computer 410.

Let us suppose a plan that the call server 330 is established in a country. This country may be divided into several areas, each of which is installed with at least one trunk gateway 332b. Besides the trunk gateway 332a, the area acting headquarters is installed with a gatekeeper 334 in charge of call management for the trunk gateways 332a, 332b which are installed in each area. The trunk gateways 332a, 332b installed in each area are networked to each other through the medium of the Internet 200. The trunk gateway 332a of the headquarters area and the gatekeeper 334 are networked over the Intranet. Each of the trunk gateways 332a, 332b in each area interfaces, through subsidiary equipment such as the router (not shown) and a private automatic branch exchange (PABX), the Internet 200 and the telecommunication network, i.e., the PSTN 500 or the mobile telecommunication network 600 with each other. This configuration can be extended to other countries. The gatekeeper 334 receives information on the request of the call connection via the web server 310 and, for controlling the trunk gateways 332a, 332b in response to the request of the call connection, it has a call connection controlling program. In connection with the trunk gateways 332a, 332b, the call connection controlling program has the functions of conducting a call connection request, a control related to the call connection and inquiries into the progressing status of the call connection.

Under this system environment, a call connecting method according to the phone-to-phone communication is explained below. When the business card receiver 400 makes a call connection request through the medium of the web business card received from a web business card transmitter 100, the web server 310 provides, in response to the request, the ID and telephone number of the business card transmitter and the telephone number of the business card receiver to the gatekeeper 334 and instructs a call connection between the business card receiver 400 and the business card transmitter 100. In response to the call connecting instruction, the gatekeeper 334 analyzes the telephone number of the business card transmitter and the telephone number of the business card receiver for selecting one or more proper trunk gateways to be in charge of the call connection. The recommendable criteria for the selecting are the availability of the trunk gateway, the possibility of the least cost, and the sound quality. According to such criteria, a trunk gateway which is available to respond to the call connection request because it is not currently overloaded, a trunk gateway which is in a position that a call connection can be made at a minimum of expense among the available trunk gateways, and a trunk gateway having a condition for providing calls of quality, etc. can be selected. For the selecting of trunk gateways based on these criteria, each of the trunk gateways 332a, 332b regularly reports to the gate keeper 334 on information for checking whether it is currently in a state alive and on the number of currently available channels which are not in use. On the basis of such information, the gatekeeper 334 selects one or more proper trunk gateways for processing the request of the call connection transmitted from the web server 310 and then instructs the call connection with transmitting the telephone number of the business card receiver and the telephone number of the business card transmitter to the selected trunk gateway.

Further, the trunk gateways 332a, 332b open call channels respectively to the telephone 120 or 130 of the business card transmitter and the telephone 420 or 430 of the business card receiver by dialing the telephone numbers transmitted from the gate keeper 334, and they open a communication channel therebetween to connect the opened call channels, thereby a full connection of communication channel between the telephone 120 or 130 of the business card transmitter and the telephone 420 or 430 of the business card receiver through the trunk gateways 332a, 332b being able to be established. In this state, a call between the business card transmitter and the business card receiver becomes possible. At this time, when the business card transmitter and the business card receiver are in the same area covered by one trunk gateway, only the trunk gateway may be involved in most cases. That is, one trunk gateway dials both telephone numbers of the business card transmitter and the business card receiver and connects the call between the telephones of both parties, and in this state the sound signal of one party goes to the other party only by way of the telecommunication networks 500, 600 and the trunk gateway. In comparison with this, when the business card transmitter and the business card receiver are not in the same area, at least two trunk gateways 332a, 332b may be selected and, by way of the telecommunication networks 500, 600, one trunk gateway dials the telephone number of the business card transmitter to establish a communication channel therebetween and the other trunk gateway dials the telephone number of the business card receiver to establish another communication channel therebetween. After this, by connecting a communication channel between the two trunk gateways via the Internet 200, the call connection between the business card transmitter and the business card receiver is established via a channel path, the telecommunication network 500 or 600 <−> the trunk gateway 332a <−> the Internet 200 <−> the trunk gateway 332b <−> the telecommunication network 500 or 600. Over the telecommunication network 500 or 600 section, a voice is transformed into a PCM signal and is transmitted in a line transmission method whereas, over the Internet 200 section, the voice is encoded and compressed as a digital signal and is transmitted in a packet transmission method. Even in the case of a long distance call or an international call, a calling fee can be reduced because the fee is charged only for the telecommunication network 500 or 600 section.

When the trunk gateways 332a, 332b relay a voice signal via the telecommunication network 500 or 600 and the Internet 200, the voice signal transmitted from the telecommunication network 500 or 600 is encoded and compressed and is transmitted to the Internet 200 packet by packet, and to the contrary, a voice packet transferred from the Internet 200 is decompressed and decoded into the original voice signal which is transmitted to the telecommunication network 500 or 600. Although these functions can be realized by software, it is particularly preferable to realize them by hardware for a real-time execution.

Meanwhile, in the case of the PC-to-phone communication which is similar to the above phone-to-phone communication, the difference which should be considered is that the business card receiver 400 uses the computer 410 as a calling means. The gatekeeper 334 selects one or more proper trunk gateways on the basis of information on an IP address of the computer 410 of the business card receiver and the telephone number of the business card transmitter, and instructs the selected trunk gateway(s) on the call connection by providing the above information. When the call connection between both parties is made, the voice signal over a range between the computer 410 and one trunk gateway, for example, 332a, always passes through the Internet 200 only, and the voice signal over a range between the telephone 120 or 130 of the business card transmitter and the other trunk gateway, for example, 332b, passes through the telecommunication network 500 or 600. When the business card transmitter and the business card receiver are in the same area, only one trunk gateway is involved. When the business card transmitter and the business card receiver are not in the same area, the two trunk gateways 332a, 332b or more are needed and they are connected with each other via the Internet 200.

Meanwhile, the web server 310 is installed with a web business card editor program by which a web business card can be made, a phone-to-phone control program and other various necessary programs. On the basis of information requested by the business card transmitter 100, the web server 310 issues a web business card desired by the business card transmitter 100 and transmits the issued web business card to at least one designated business card receiver 400 via e-mail, etc. In particular, a call connection request, a call control and an order for inquiring into a call connection in respect to the trunk gateways 332a, 332b are carried out by the phone-to-phone control program.

In addition, the service system 300 can provide other subsidiary services in variety. For instance, for the situation that the business card transmitter cannot answer the telephone, there are provided some additional functions: a guiding message function for storing a guiding message of the business card transmitter in response to the received call and for providing the message to a person who requested the call, i.e., the business card receiver; a call reservation function for receiving a call reservation from a business card receiver who wants to call the business card transmitter and for connecting the call with the business card transmitter in desired time; and a recording service function for recording the contents of the call, when the call is answered to the database server 320 in file form by the call server 330, and for providing the contents of the recorded call when the business card transmitter wants. These functions are provided in cooperation with the web server 310, the database server 320 and the call server 330 in response to the client's request, and, for such subsidiary services, a subsidiary service database 326 is prepared to store and manage recording information, call reservation information, guiding instruction information, etc. In addition, in response to each client's request, there is further provided a service for checking a calling fee, advance payment of the calling fee, a calling statement, etc.

Next, on the basis of the service system 300, a method of providing call connecting service between the business card receiver and the business card transmitter through the medium of the web business card is concretely explained below.

The issue and transmission of the web business card is first explained.

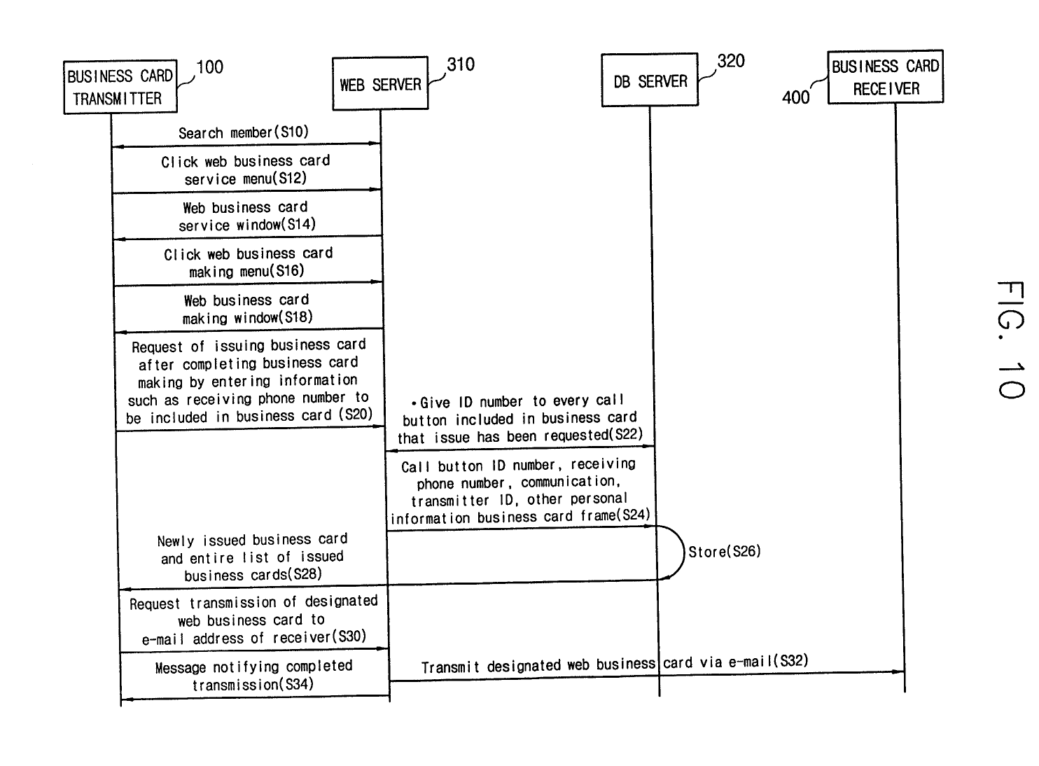

FIG. 10 is a flow chart of a process that the business card transmitter 100 obtains a desired web business card, via his or her own computer 110, issued by the service system 300 according to the present invention.

In response to the access of the computer 110 of the business card transmitter, the web server 310 provides a web page for the issue of the web business card to the computer 110. The web page is made in the HTML document based on a graphic user interface (GUI) and menus for issuing the web business card are prepared therein.

The business card transmitter 100 can start a process for issuing the web business card by carrying out the menus for issuing the web business card (S12) after receiving the web page from the web server 310 by driving a web browser installed in the computer 110. When the call connecting service through the medium of the web business card is run by a membership system, it is preferable to first undergo the necessary processes for joining and legalizing the membership (S10) by checking a member ID and a password inputted with the member database 322 in the computer 110. In the case of a member, further services are provided. In the case of a non-member, a process for a new membership is invited and the inputted member information is stored in the member database 322. In the case of joining the membership, advance payment of a calling fee in a certain amount can be provided for the new member to induce the use of this service.

When the computer 110 carries out the menus for the web business card service on the web page, the web server 310 provides a prepared window for the web business card service (S14). The web business card service window is provided with various menus having the functions of making a business card, amending the old business card, deleting the old business card, viewing a list of old business cards and transmitting the business cards, together with a guiding function and a subsidiary function.

The business card making menu should be carried out to make a web business card (S16). Once this menu is carried out, the web server 310 provides the computer 110 with a window in which the web business card can be made (S18). The web business card making window provides web business card making tools.

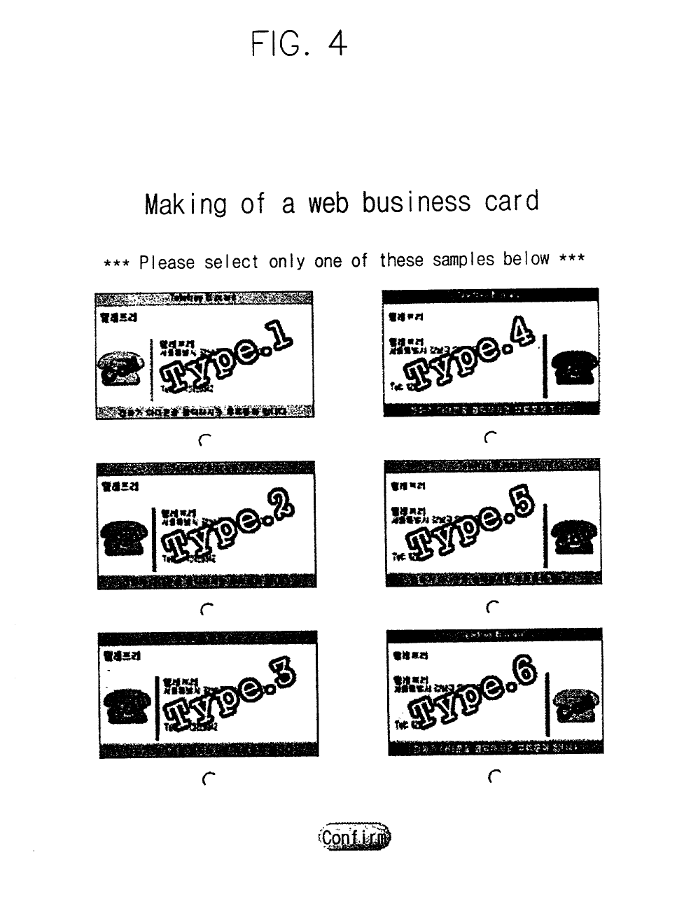

A first making tool enables the business card transmitter to easily and simply make the web business card. When the first making tool is used, the business card transmitter receives a plurality of sample business cards designed with various layouts and background colors as illustrated in FIG. 4. The business card transmitter can select one from these sample business cards, enters personal information such as his or her telephone number and name, and instruct a business card making. In response to the making instructions, as in a business card 30 illustrated in FIG. 3, the first making tool combines the entered personal information 36 and the telephone number 32 with the selected business card sample by disposing them in a predetermined position, and automatically generates the web business card in which a call button 34 having a function capable of connecting a call to the telephone number 32 is included concurrently in a proper position. As such the web business card can be conveniently made as the first making tool automatically makes it, and the works that the business card transmitter should do are to enter basic personal information and to select a desired sample business card.

Meanwhile, a second making tool is so provided as to make a web business card of a marked characteristic by designing it in a desired form. The second making tool may not only include much more information in the web business card, but also provide a function that the feature of the web business card is variously edited.

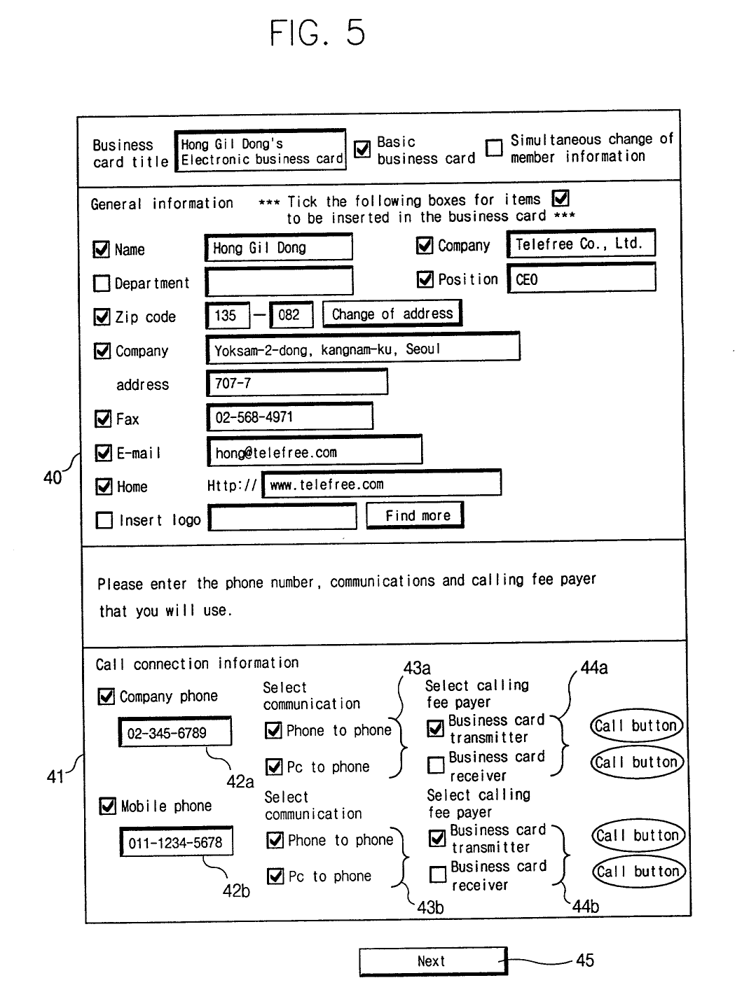

FIG. 5 illustrates a layout of a window for entering the business card transmitter's information at the time of making the web business card with the second making tool. When the making of the web business card with the second making tool is selected, the window for entering the information is provided on a window of the computer 110. The window for entering the information comprises a general information input section 40 and a call connection information input section 41. The general information input section 40 is provided with input boxes into which general information such as the business card transmitter's name, company name, department, position title, address, facsimile number, e-mail address, home page address, character, company logo, and the like are entered. The call connection information input section 41 is provided with input boxes 42a, 42b for entering the business card transmitter's company (or home) telephone number and mobile phone number, checking sections 43a, 43b for selecting a communication method for the respective phone numbers, checking sections 44a, 44b for selecting a calling fee payer and a call button image selector, etc. The checking sections 43a, 43b are provided with, for example, the PC-to-phone communication and the phone-to-phone communication as a communication method selecting menu for the corresponding telephone number, and the business card transmitter can select all or part of them. The checking sections 44a, 44b are provided with a menu for selecting who pays the calling fee when the business card receiver calls on the telephone number concerned. The business card transmitter can select either himself/herself or the business card receiver. When the business card transmitter wants to share the fee, he or she selects both parties.

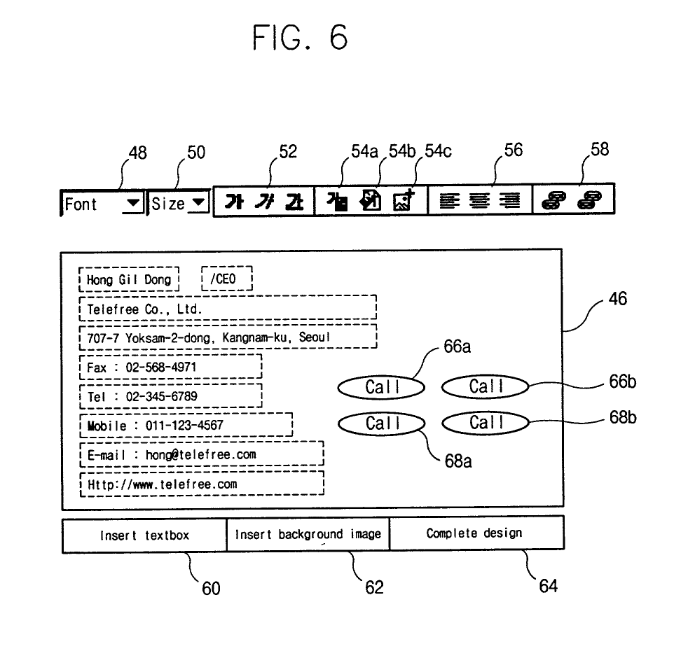

Information which is intended to be selected or to be included in the web business card is marked in an appropriate box. When the business card transmitter inputs necessary information into these information inputting windows and clicks a ‘next’ button 45, the second making tool makes a draft 46 of the business card as illustrated in FIG. 6. The information within the draft 46 is the information marked in the boxes among the inputted information in the information inputting sections 40, 41 of FIG. 5.

The draft 46 of the business card of FIG. 6 includes at least one or more call buttons 66a, 66b, 68a, 68b. Each of the call buttons 66a, 66b, 68a, 68b corresponds to a combination of one telephone number and one communication method. The first call button 66a and the second call button 66b are the call buttons respectively corresponding to the PC-to-phone communication and the phone-to-phone communication with respect to the telephone number 02-345-6789. And also, the third call button 68a and the fourth call button 68b are the call buttons respectively corresponding to the PC-to-phone communication and the phone-to-phone communication with respect to the telephone number 011-123-4567.

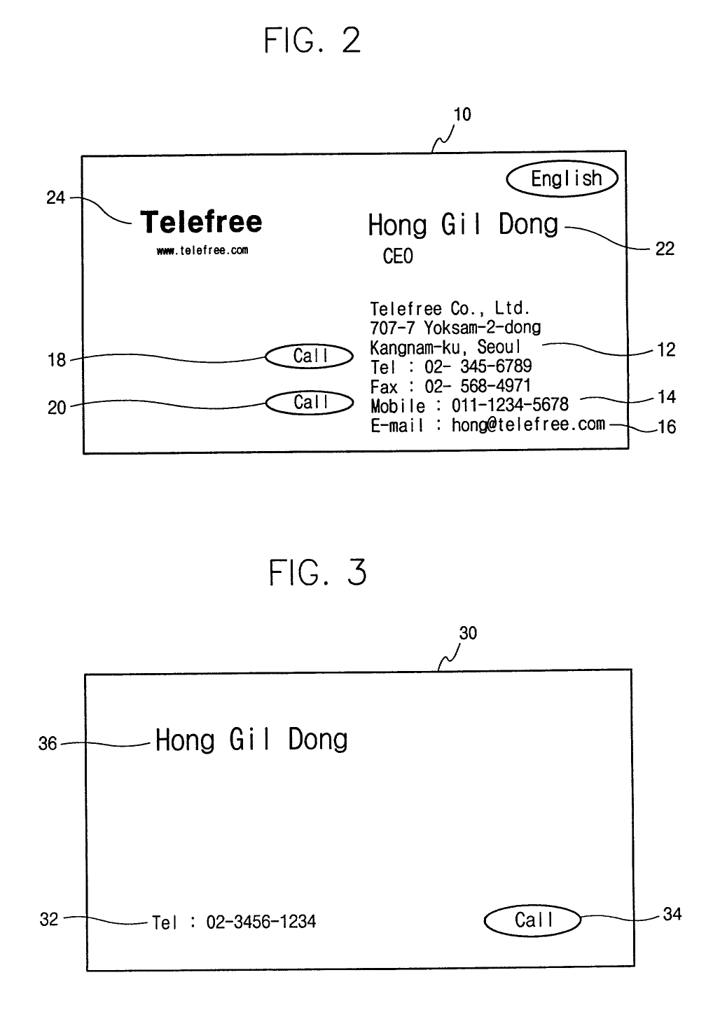

The second making tool provides various editing tools for the business card transmitter to design the web business card in a desired form. The second making tool provides, as shown in FIG. 6, a font selecting menu 48, a font size selecting menu 50, a font style menu 52 for boldfaces, italics, underlines, etc., a font color selecting menu 54a, a background pattern inserting menu 54b, an image inserting menu 54c, an alignment selecting menu 56, a link and link removal menu 58, and the like. In addition, the second making tool provides an additional letterbox inserting function 60 and a background image inserting function 62. When the making of the business card is instructed by clicking a ‘design completion’ button 64 after the business card is edited as a desired form with such editing tools, a completed business card is displayed on the screen of the computer 110 as illustrated in FIG. 2. For instance, the completed business card 10 may contain not only the business card transmitter's name 22, company name 24, address, facsimile number and email address 16, but also his or her telephone number 12, mobile phone number 14 and call buttons 18, 20 corresponding to the two phone numbers, respectively. Further, it is preferable to add a function that the web business card is converted to various language versions for its international use.

Each of the call buttons included in the web business card is designed to have a function, when it is checked, for generating an event requesting the call connection to the telephone number corresponding to the clicked call button with respect to the web server 310. In order to support plural communication methods such as the phone-to-phone communication and the PC-to-phone communication for each telephone number, it is preferable to prepare the call buttons defining the communication methods in the web business card by the same number with the number of the plural communication methods for each of the telephone numbers. That is, one combination of, and a telephone number of, the business card transmitter and a communication method are mapped to one call button. In the case that only one communication method is serviced to every telephone number included in the web business card, it is possible that the telephone number itself can be used as a call button without making extra call buttons by providing the same function with the call button to each telephone number included in the web business card. In this case, it is necessary to further provide a process of checking the business card receiver's choice as to the communication method.

The business card transmitter 100, after making the business card by using either of the two web business card making tools, can request the issue of the web business card. If there is such a request, the web server 310 carries out several internal processes in the service system 300 for the issue of the web business card. First, the web server 310 inquires into the database server 320 for the issue of a new web business card and assigns an ID number for every call button 18, 20 included in the web business card that the computer 110 requested the issue (S22).

By using the call buttons having such a call connection function, the business card receiver 400 can make a request of the call connection with the business card transmitter 100. In the service system 300, each of the call buttons is recognized by the ID number. After assigning the ID numbers for the call buttons, the web server 310 provides information related to the web business card, together with the ID numbers of the call buttons, to the data server 320 (S24). The data server 320 stores such data as the business card transmitter's receiving telephone number, the communication method corresponding to each of the call buttons, ID number, and other personal information of the business card transmitter and web business card skin, which are provided by the web server 310, in the web business card database 324 (S26).

After undergoing these preparations for issuing, the web server 310 provides the computer 110 with a newly issued web business card and a list of the business card transmitter's entire business cards (S28). The issued web business card is transmitted to the e-mail address of the business card transmitter. The issued web business card may be a file made by the HTML. When there exist already issued web business cards, it is preferable to provide a list of them concurrently. The business card transmitter can perform a final check in relation to the already issued web business cards.

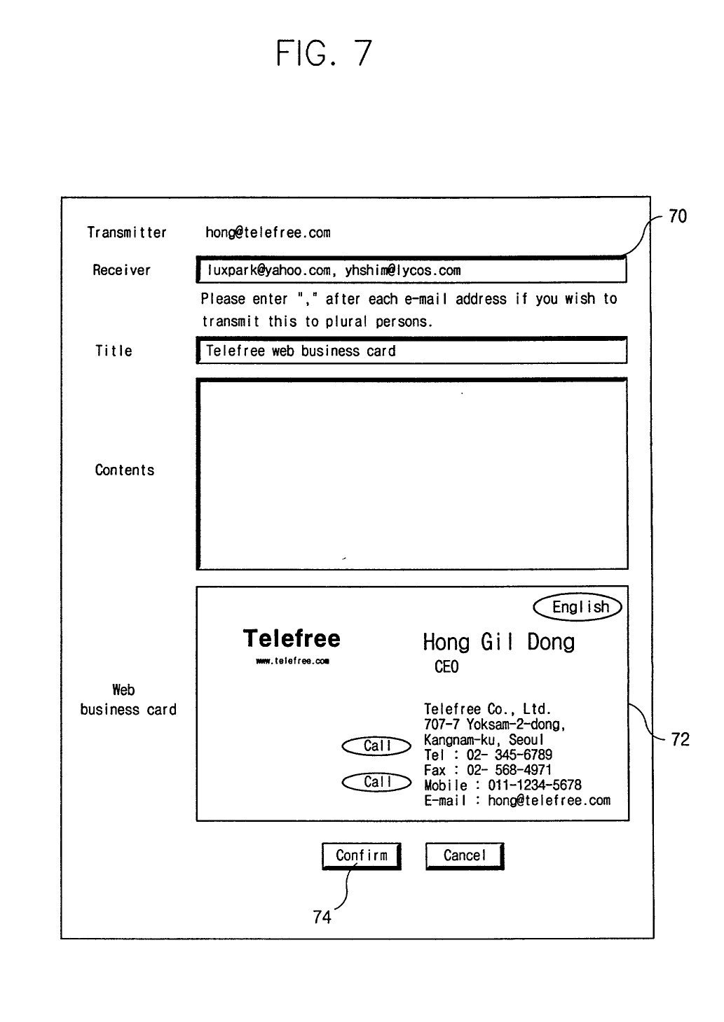

After the web business card is issued based on the above method, the issued web business card needs to undergo a process of being transmitted to a third party via e-mail. For this, the business card transmitter designates the web business card which is intended to be transmitted from the list of web business cards transmitted from the service system 300 as a basic web business card and requests a business card transmitting window. In response to this request, the web server 310 provides the computer 110 with such a business card transmitting window as illustrated in FIG. 7. A web business card 72 to be transmitted is also included in the business card transmitting window. The business card transmitter enters one or more e-mail addresses of one or more business card receivers to whom the web business card 72 is to be transmitted into an address inputting box 70 of the business card transmitting window, together with the proper headings of the matter and the contents, and requests business card transmission by clicking a ‘confirm’ button 74 (S30). When there are a plurality of business card receivers, the respective e-mail addresses are written with commas or semi-colons.

When such a business card transmission is requested, the web server 310 transmits the web business card to the designated e-mail addresses (S32). Once the transmission is completed, a transmission completed message is transmitted to the e-mail address of the business card transmitter 100 (S34).

Based on the above processes, the business card transmitter can make his or her web business card and transmit the same via e-mail to the desired receivers by using the service system 300. Besides, the service system 300 provides the function that whenever he or she sends an e-mail message to a person, the business card transmitter can make the web business card, received from the service system 300, be automatically attached to the e-mail message by using an automatic attachment function supported by an e-mailing program, for example, Outlook Express.

The web business card to which the business card receiver accesses always needs to have updated information, and for this, the service system 300 uses the following method. It has already been mentioned that the web business card issued by the service system 300 can be made in the HTML file and stored in the web business card database 324 and, if necessary, the business card transmitter 400 can modify information of the issued web business card. When the business card transmitter modifies the existing web business card, the existing web business card stored in the web business card database 324 is renewed to a modified web business card. The web business card that the business card receiver sees via the computer 410 needs to be the most recently renewed one, but not the existing one. For this, the web server 310 transmits link information together with the web business card to the business card receiver via e-mail. That link information makes a link between the web business card transmitted to the web business card receiver and a corresponding web business card stored in the web business card database 324. When the business card receiver 400 opens the e-mail message in which the web business card is included (S40), the computer 410 transmits the link information to the web server 310 via the Internet 200, and the web server 310 transfers the link information to the database server 320 and requests the latest web business card corresponding to the link information (S42). The database server 320 finds the web business card corresponding to the link information from the web business card database 324 and transmits it to the web server 310. Since the web server 310 provides the web business card from the database server 320 to the computer 410, the web business card that the business card receiver sees in his or her own computer 410 is always the latest web business card stored in the web business card database 324 (S44).

According to this method, when certain information of a web business card needs to be modified, the works that the business card transmitter should do are to access to the service system 300 and to do on-line modifications of desired information which is stored in the web business card database 324. Once such modification has been done, the business card receiver can always access to the latest web business card version regardless of the web business card version transmitted to the business card receiver. Thus, the business card transmitter conveniently processes the information renewal of the already transmitted web business card.

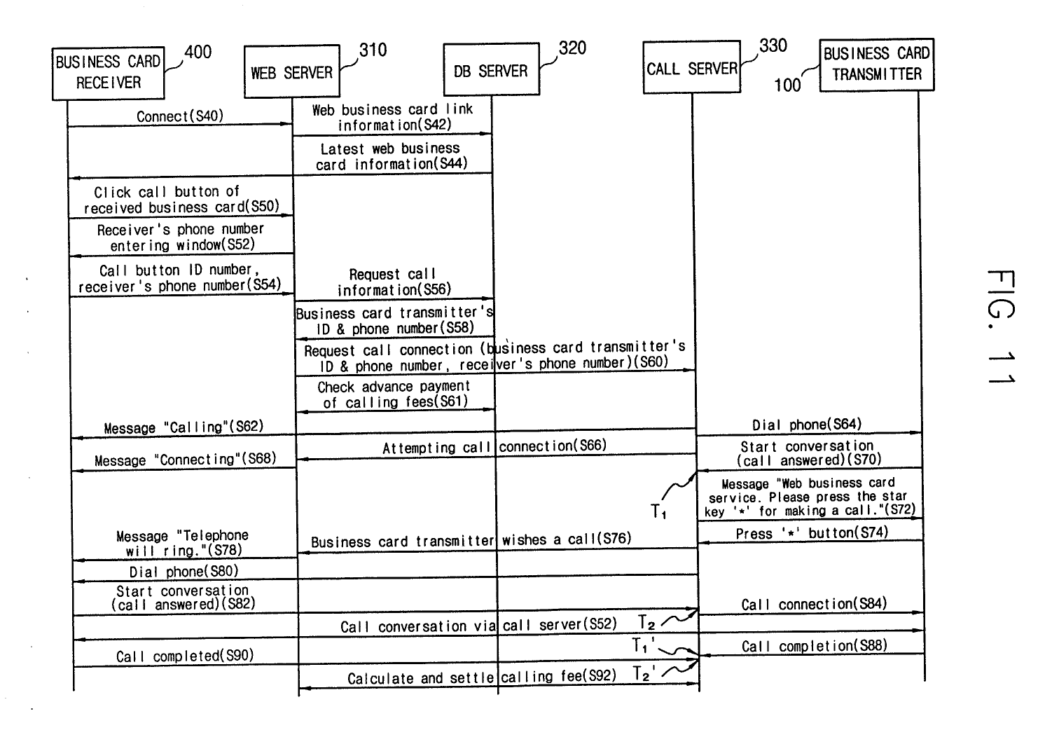

Next, there is explained a call connection method between the business card transmitter and the business card receiver through the medium of the web business card. FIG. 11 illustrates a process that the business card receiver who received the web business card via the service system 300 receives call connecting service by the phone-to-phone communication method between his or her telephone (420 or 430) and the business card transmitter's telephone (120 or 130) through the medium of the web business card. For convenience of explanation, let us suppose that the business card receiver 400 has received the web business card illustrated in FIG. 2.

The first step for the call connection with the web business card transmitter is that the business card receiver 400 sees the received web business card in his or her computer 410 and then click either of the call buttons 18, 20 included in the web business card when he or she wants to have a call with the business card transmitter 100 (S50).

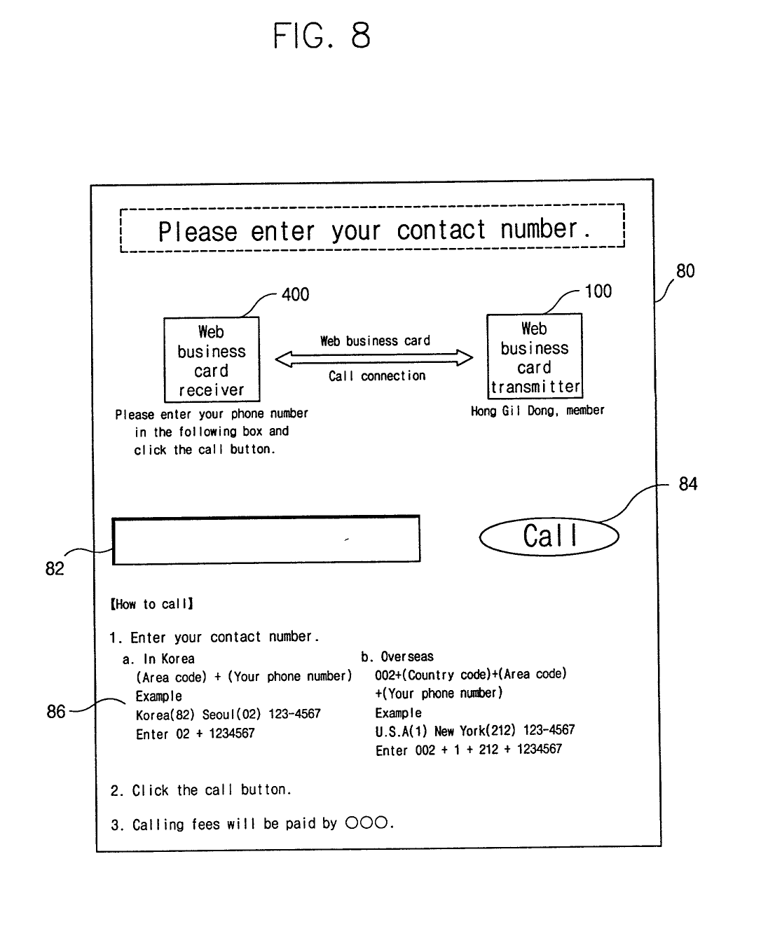

Since uniform resource locator (URL) information of the web server 310 is included in the web business card, the business card receiver's computer 410 is connected to the web server 310 as a client when he or she opens the received web business card. When the computer 410 is connected, the web server 310 provides a telephone number inputting window 80 to the computer 410 as illustrated in FIG. 8. The business card receiver 400 should input a telephone number that he or she intends to use during the call with the business card transmitter 100 into a telephone number inputting box 82 in the telephone number inputting window 80 and click the call button 84 for requesting the call connection with the business card transmitter 100 (S54). In the inputting window 80, it is preferable to provide guidelines 86 informing first time users of who pays a calling fee and how to do a call connection request. When the call connection request is performed, the ID number of the call button clicked together with the telephone number of the business card receiver is transmitted from the computer 410 to the web server 310.

In response to such a call connection request, the web server 310 transmits call connection request information, i.e., the ID number of the call button, to the database server 320 in order to inquiry into information necessary for a call connection with the business card transmitter 100 (S56). In reply to the inquiry, the database server 320 transmits to the web server 310 call connection information, for example, the business card transmitter's telephone number, ID, communication method, etc., corresponding to the transmitted ID number of the call button, by means of searching it from the web business card database 324 (S58).

The web server 310 through this process secures all necessary information for the call connection between the business card receiver and the business card transmitter and requests the call connection to the call server 330 (S60). For the call connection, the web server 310 provides the call server 330 with the necessary information for the call connection between the business card transmitter and the business card receiver, i.e., the telephone numbers of both the business card transmitter and the business card receiver. In addition, other necessary information for charging a calling fee such as the business card transmitter's or the business card receiver's ID can be provided.

In response to the call connection request of the web server 310, the call server 330 informs, via the web server 310, the business card receiver via the computer 410 that it is calling the business card transmitter (S62) while it dials the telephone number of the transmitted business card transmitter 100 (S64).

On the other hand, the call server 330 makes the business card receiver know in real time through the business card receiver's computer 410 via the web server 310 how the call connection proceeds by transmitting the fact that the call connection to the business card transmitter's telephone number is attempted (SS66, 68).

When the business card transmitter answers the telephone, the call server 330 sends the business card transmitter guiding messages that a call connection has now been attempted via the web business card and he or she may press a certain button, for example, ‘*’ when he or she wants the call with the business card receiver (SS70, 72). Whether the call is answered or not can be verified by detecting an off-hook signal in the case of the telephone and the call button signal in the case of the mobile phone.

When the business card transmitter 100 presses the button ‘*’, the call server 330 regards the business card transmitter as having an intention to receive the call and informs the intention to the web server 310 (S76). The web server 310 transmits the guiding message “a telephone will ring” to the business card receiver's computer 410, so that the business card receiver can prepare a call receipt (S78).

With holding the call to the telephone 120 or the mobile phone 130 of the business card transmitter, the call server 330 dials the telephone number of the business card receiver (S80). When the receipt of the call by the business card receiver is checked (S82), the call server 330 connects a call between the business card transmitter's phone and the business card receiver's phone (S84). Unlike the above situation, a dialing for the call connection can be first carried out for the business card receiver.

By doing so, the business card transmitter and the business card receiver can have a telephone conversation over the telephone 120 or 130 and the telephone 420 or 430, respectively. Here, let us suppose that the business card receiver 400 and the business card transmitter 100 are located in different areas from each other. Concretely speaking, in this case, a call connection is established by the trunk gateways 332a, 332b of each area according to control of the gatekeeper 334 as explained above. That is, the gate keeper 334 selects the optimal trunk gateways, for example, 332a, 332b to be in charge of a call connection on the basis of call connection information such as the respective telephone numbers of the business card transmitter and the business card receiver received from the web server 310, and instructs the selected trunk gateways to establish the call connection by transmitting the telephone number of the business card receiver and the telephone number of the business card transmitter to the selected trunk gateways. Then, after the trunk gateways 332a, 332b dial the business card transmitter and the business card receiver and open call channels with both parties' telephones, respectively, they open a communication channel therebetween to connect the call channels between the two telephones. In the case that the business card transmitter and the business card receiver are in the same area, any one of the trunk gateways can handle such a call connection without having plural trunk gateways participated.

After the connection of the call, the call server 330 checks whether the call is ended, i.e., disconnected, or not with monitoring the call status of each telephone to which the call is connected (SS88, 90). Such a checking is made by detecting the on-hook signal in the case of the telephone and by detecting a call completion signal in the case of the mobile phone. When the call disconnection is checked, a calling fee is calculated (S92). Various methods of calculating the calling fee can be used. As an example, respectively for the business card transmitter and the business card receiver, the calculation of a calling fee may be done on a time basis by counting the time from the point that a call is received to the point that the call is disconnected. When this method is applied to FIG. 11, the calling time of the business card transmitter becomes T1˜T1′, and the calling time of the business card receiver becomes T2˜T2′.

In the case that such a call connection service is provided with fees, it is necessary to have a managing method of charging fees and making payment. The calling fee is charged for a fee payer who is selected at the time of making the web business card (refer to FIG. 5). A method of advance payment and deferred calculation can be an example of charging fees and making payment. According to this method, a provider of the service system 300 registers the business card transmitter as a member and makes the registered member pays a calling fee in the certain amount in advance. The advanced payment of the calling fee is recorded in the web business card database 324. When the business card receiver makes a call connection request, the web server 310 inquires into the database server 320 the advance payment of the calling fee of the business card transmitter corresponding to the requested telephone number (S61). When the inquired advance payment of the calling fee is below a limit amount, the web server 310 notifies the business card transmitter and the business card receiver of lack of the advance payment and that the call connection service cannot be currently provided, accordingly. The call connection server to the business card transmitter is provided only for the case that the advance payment is above the limit amount and the calculated calling fee is deducted from the advance payment.

As another method, a deferred payment system which is similar to a general calling fee payment system can be applied. In this case, unless the provider of the service system 300 directly runs the PSTN 500 or the mobile telecommunication network 600, it is preferable for the provider of the service system 300 to provide the call connection service jointly with one or more telecommunication providers running these telecommunication networks 500, 600 via affiliation and to share the calling fee with the telecommunication providers. That is, each telecommunication provider charges the calculated calling fee for each telephone number and the provider of the service system 300 receives a certain proportion of the charged calling fee distributed by the telecommunication providers. According to this method, the problem that a call connection is rejected due to the lack of the advance payment does not occur. For exact calculation, it is preferable to respectively calculate the calling fee by the service system 300 and the telecommunication providers.

Meanwhile, in order to increase the success rate of the call connection with the business card transmitter 100, when plural telephone numbers are included in the web business card of the business card transmitter 100, it may be worth considering a method that, when a call connection to the telephone of the telephone number corresponding to the call button clicked by the business card receiver is not available, the service system 300 switches the trial of the call connection to any other telephone number.

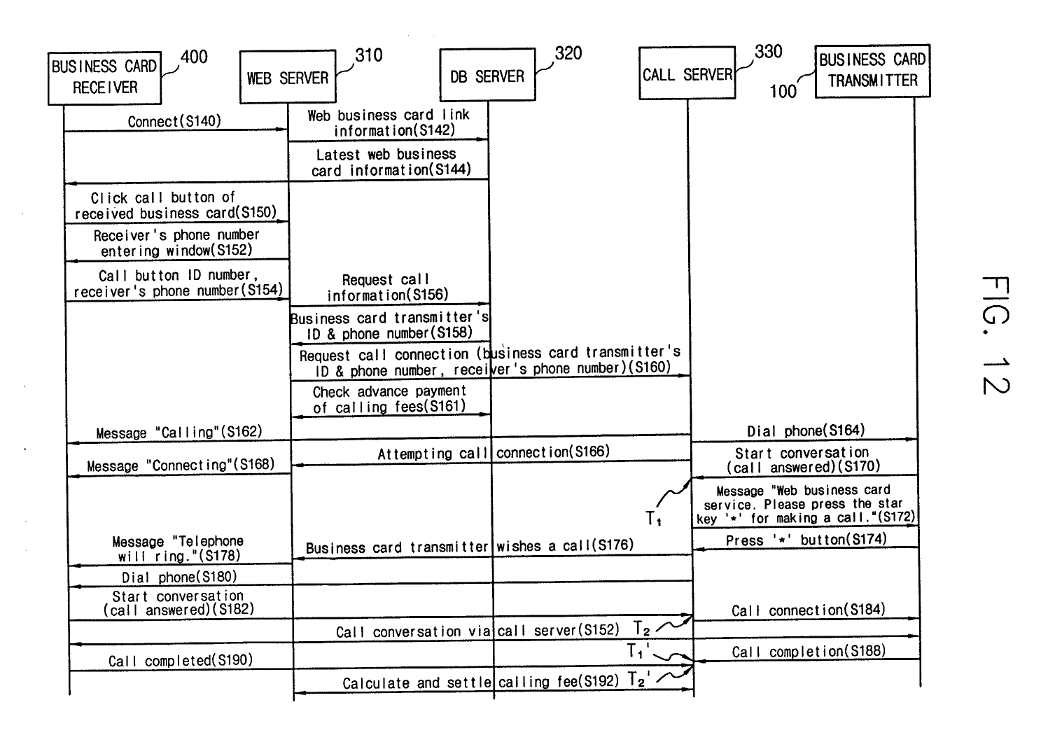

Next, with reference to FIG. 12, there is explained a call connection service method of the PC-to-phone communication that the business card receiver 400 uses the computer 410 and the business card transmitter uses the telephone 120 or 130. When the business card receiver 400 clicks the call button of the received web business card in the computer 410 (S150), the ID number of the call button clicked together with its IP address are transmitted from the computer 410 to the web server 310 (S152). The web server 310 provides the received ID number of the call button to the database server 320 (S156) and receives the telephone number of the business card transmitter and his or her ID which correspond to the ID number of the call button from the database server 320 (S158). Then, the web server 310 transmits the IP address of the business card receiver 400 and the telephone number and ID of the business card transmitter to the call server 330 to request the call connection between the business card transmitter's telephone 120 or 130 and the business card receiver's PC 410 (S160). The call server 330 selects one or more trunk gateways based on the information from the web server 310. The selected trunk gateways confirm a calling intension by dialing the telephone number of the business card transmitter 100 (SS164, 170, 172, 174, 176) and then open a communication channel to the telephone number of the business card transmitter 100. And also, the selected trunk gateways open another communication channel with the computer 410 by using the IP address of the business card receiver (SS 180, 182). Then, the selected trunk gateways establish the call connection between the business card receiver's computer 410 and the business card transmitter's telephone 120 or 130 by connecting both communication channels for both the business card receiver and the business card transmitter (S184). As explained above, the trunk gateways provided for the call connection service are optimally determined according to the above-mentioned criteria for the selection of them such as the location of the business card receiver and the business card transmitter, the availability of each trunk gateway, low costs, etc. Then, the processes of checking the end of the call between both parties, calculating and paying the calling fee (SS190, 192), guiding the call connection status (SS162, 166, 168, 178), etc. are successively carried out.

The call connection based on the phone-to-PC communication method that the business card transmitter 100 uses the computer 110 and the business card receiver 400 uses the telephone 420 or 430 can be provided in the similar manner as above and the person skilled in the art can easily realize it based on the above explanations.

As explained above, the prior web business card could not function as a medium of the call connection. However, according to the present invention, the business card receiver can easily and conveniently have the call connection with the business card transmitter through the medium of the web business card. As being run based on the Internet 200 and the telecommunication networks 500, 600, this call connecting service can be provided at a cheaper calling fee than the general prior call connection service. The reason is that massive use of call connecting service of the present invention can bestow a great deal of profits on the providers of the telecommunication networks 500, 600, accordingly they can afford to reduce the calling fees. Therefore, using this call connecting service which charges discounted calling fees is more advantageous to users than making calls between the parties without using the web business card.

The present invention provides users with a variety of options in the call connecting service. The users can use both the phones and his or her own PC as a communication device. Further, the business card transmitter can choose a method of paying the calling fee at the time of making the web business card. If the business card transmitter selects himself or herself as a calling fee payer, more call connections with the business card receivers can be induced.

In addition, since the business card receiver can always access to the web business card in which the latest information of the business card transmitter is reflected, there are advantages that any inconvenience caused by inaccurate information does not occur and that the business card transmitter can conveniently manage business card information.

In the case that a company uses the call connecting service according to the present invention, it can have an effect that its publicity is promoted by making its employees insert its advertisement while paying its calling fees.

In respect to the making of the web business card, the business card transmitter can design a business card reflecting his or her individual characteristics by using the web business card making tools having a web editing function.

Although the preferred embodiments of the invention have been described, it will be understood by those skilled in the art that the present invention should not be limited to the described preferred embodiments, but various changes and modifications can be made within the spirit and scope of the invention as defined by the appended claims.

What is claimed is:

1. A method of providing a call connection service between a first party and a second party by using a system connected to a PSTN and/or a mobile telecommunication network and the Internet, comprising the steps of:
issuing a web business card, in response to a request of the first party by a first client computer via the Internet, including at least one or more call buttons having a call connection requesting function based on web business card information provided by the first party via the first client computer, and transmitting the web business card to one or more e-mail addresses designated by the first party;
in response to a call connection request, activated by clicking the call button of the web business card in a second client computer, via the Internet by the second party received the web business card of the first party via e-mail, receiving from the second client computer call connection information of a communication means to be used by the second party, and respectively dialing a telephone number corresponding to the clicked call button of the first party and the call connection information of the communication means of the second party; and
connecting a call between a telephone of the first party and the communication means of the second party when the first party and the second party respond to a call connection attempted by the dialing, and thereby the call connection service between the first party and the second party being provided by the system through the medium of the web business card.

2. The method as claimed in claim 1, wherein the call connection information of the communication means of the second party is an Internet protocol address of the second client computer to be used by the second party for the call.

3. The method as claimed in claim 1, wherein the call connection information of the communication means of the second party is a telephone number of a telephone to be used by the second party for the call.

4. The method as claimed in claim 1, further comprising the steps of providing the first client computer with a web business card list of the first party stored in the system in response to the first party's request, receiving at least one or more e-mail addresses from the first party via the first client computer, and transmitting a certain web business card selected by the first party from the web business card list to the received e-mail addresses.

5. The method as claimed in claim 1, further comprising the step of calculating a calling fee by counting a calling period of time between the first and second parties.

6. The method as claimed in claim 5, further comprising the steps of storing data of an advance payment paid by the first party in a database and deducting the advance payment from the calculated calling fee.

7. The method as claimed in claim 6, further comprising the steps of, when there is a call connection request of the second party, checking the advance payment of the first party and notifying, via a call or e-mail, the first party and/or the second party of a message that the call connection request cannot be serviced when the advance payment is smaller than a predetermined limit amount.

8. The method as claimed in claim 1, wherein the system provides, for issuing the web business card, the first client computer with a web page in which a web business card making means is included in response to the first party's request.

9. The method as claimed in claim 8, wherein the web business card making means has the functions of providing the first client computer with an information input window in which personal information, including at least the first party's telephone number, to be included in the web business card is entered by the first party, providing the first client computer with a web business card draft, after receiving the personal information from the first client computer, in which at least one or more call buttons together with the inputted personal information are arranged in a predetermined position, allowing the first party to insert additional matter into the web business card draft and edit the web business card draft's layout, background, color, font or size as he or she wants, and producing a web business card for the issuing.

10. The method as claimed in claim 8, wherein the web business card making means has the functions of providing the first client computer with an information input window in which personal information, including at least the first party's telephone number, to be included in the web business card is entered by the first party together with at least one or more prepared web business card samples and, after receiving the personal information and the first party's selection of a desired web business card sample from the first client computer, producing a web business card by arranging the personal information and the call button in a predetermined position of the selected web business card sample.

11. The method as claimed in claim 1, wherein the steps of issuing and transmitting the web business card, comprising the steps of:
providing the first client computer with a web page including a web business card making means in response to the request of the first party;
receiving, by the system, the web business card made by the first party with the web business card making means from the first client computer, the received web business card including at least one or more call buttons and the first party's telephone number which corresponds to each call button;
storing the received web business card, together with an ID number which is given by the system with respect to each call button which is included in the received web business card, in a database of the system; and
transmitting the web business card for the issuing to an e-mail address of the first party.

12. The method as claimed in claim 11, further comprising the steps of, in response to a request of the first party, providing the first client computer with a web page including information related to the web business card of the first party after extracting the web business card from the database and, when the first party requests a renewal by correcting the information, updating the database with the corrected information.

13. The method as claimed in claim 1, wherein the web business card is stored in a database managed by the system, wherein the web business card transmitted to the second party includes link information which can specify a corresponding web business card among stored web business cards in the database, wherein when the second client computer accesses to the system, the system receives the link information from the second client computer, extracting from the database a web business card which corresponds to the link information and providing the second client computer with the extracted web business card, and wherein the web business card which is displayed on the second client computer is the web business card currently stored in the database.

14. A system providing a call connection service between a first party and a second party through the medium of a web business card by comprising:
a web server connected to the Internet;
a call server which is connected internally to the web server and externally to the Internet, a PSTN and/or a mobile telecommunication network; and
a database server connected to the web server and the call server,
the web server comprising the functions of issuing the web business card including at least one or more call buttons, which have a call connection requesting function, made based on web business card information which is provided by the first party via a first client computer, transmitting the web business card designated by the first party via the first client computer to at least one or more e-mail addresses designated by the first party, and when the second party received the web business card via e-mail executes a call connection requesting function of a specific call button included in the web business card by using a second client computer, in response to the execution, inquiring into the first party's telephone number corresponding to the specific call button in the database server, and transmitting call connection information of a communicating means of the second party, together with the telephone number of the first party to the call server,
the call server comprising the functions of respectively dialing the telephone number of the first party and the call connection information of the second party which are transmitted from the web server and, when the first party and the second party respond to a call connection, connecting a call between a telephone of the first party and the communication means of the second party, and
the database server comprising the functions of storing member information provided via the web server and/or the call server, information related to the web business card, information related to the call between the first party and the second party, etc. in a database, and providing a database-related service such as a renewal of stored data and a response to requested data.

15. The system as claimed in claim 14, wherein the call connection information of the communication means of the second party is an Internet protocol address of the second client computer to be used by the second party for a call.

16. The system as claimed in claim 14, wherein the call connection information of the communication means of the second party is a telephone number of a telephone to be used by the second party for a call.

17. The system as claimed in claim 14, wherein the web server further comprises the function of providing the first client computer with a web page including a web business card making means for issuing the web business card in response to a request of the first client computer and wherein the web business card making means has the functions of providing the first client computer with an information input window in which personal information, including at least the first party's telephone number, to be included in the web business card is entered by the first party, providing the first client computer with a web business card draft, after receiving the personal information from the first client computer, in which at least one or more call buttons together with the inputted personal information are arranged in a predetermined position, allowing the first party to insert additional matter into the web business card draft and edit the web business card draft's layout, background, color, font or size as he or she wants, and producing a web business card for the issuing.

18. The system as claimed in claim 14, wherein the web server further comprises the function of providing the first client computer with a web page including a web business card making means for issuing the web business card in response to a request of the first client computer and wherein the web business card making means has the functions of providing the first client computer with an information input window in which personal information, including at least the first party's telephone number, to be included in the web business card is entered by the first party together with at least one or more prepared web business card samples and, after receiving the personal information and the first party's selection of a desired web business card sample from the first client computer, producing a web business card by arranging the personal information and the call button in a predetermined position of the selected web business card sample.

19. The system as claimed in claim 14, wherein the call server further comprises the function of calculating calling fees incurred by calls between the first and second parties.

20. The system as claimed in claim 19, wherein the call server further comprises the function of deducting the calculated calling fees from advance payments of the first party and/or the second party in cooperation with the database server.

21. The system as claimed in claim 14, wherein the web business card transmitted to the second party includes link information which can specify a corresponding web business card among stored web business cards in the database, wherein when the second client computer accesses to the web server, the web server receives the link information from the second client computer, extracting a web business card which corresponds to the link information from the database via the database server and providing the second client computer with the extracted web business card, and wherein the web business card which is displayed on the second client computer is a web business card currently stored in the database.

22. The system as claimed in claim 14, wherein the call server includes a gate keeping means and one or more trunk gateway means,
wherein the gate keeping means selects at least one or more trunk gateway means which are capable of performing a call connection at the least cost among available trunk gateway means based on the first party's telephone number and the second party's telephone number which are transmitted from the web server and which instruct the call connection by transmitting the first party's telephone number and the second party's telephone number to the selected trunk gateway means, and
wherein the selected trunk gateway means dial the first party's telephone number and the second party's telephone number to open communication channels, respectively, and perform controls for establishing the call connection between the first party's telephone number and the second party's telephone number, so that both parties can have a telephone conversation.

23. The system as claimed in claim 14, wherein the call server includes a gate keeping means and one or more trunk gateway means,
wherein the gate keeping means selects at least one or more trunk gateway means which are capable of performing a call connection at the least cost among available trunk gateway means based on the first party's telephone number and the second party's using Internet protocol address which are transmitted from the web server and which instruct the call connection by transmitting the first party's telephone number and the second party's Internet protocol address to the selected trunk gateway means, and
wherein the selected trunk gateway means dial the first party's telephone number and the Internet protocol address of the second client to open communication channels, respectively, and perform controls for establishing the call connection between the first party's telephone number and the second party's second client computer, so that both parties can have a phone conversation.

24. The system as claimed in claim 14, wherein the web server further comprises the functions of, in response to a request of the first party, providing the first client computer with a web page including the information related to the web business card of the first party after extracting the web business card from the database and, when the first party requests a renewal by correcting the information, updating the database with the corrected information.

25. The system as claimed in claim 14, wherein the web server further comprises the functions of: providing the first client computer with a web page in which a web business card making means is included for issuing the web business card in response to the first party's request; receiving from the first client computer the web business card, which includes at least one or more call buttons and the first party's telephone number corresponding to each call button, made by the first party with the web business card making means; and storing, concurrently with assigning an ID number to each call button of the web business card, the received web business card together with the assigned ID number in the database.
